(19) United States
(12) Patent Application Publication
(10) Pub. No.: US 2013/0168508 A1
(43) Pub. Date: Jul. 4, 2013

(54) CABLE MANAGEMENT SYSTEM

(71) Applicant: Todd E. Smeltzer, Red Lion, PA (US)

(72) Inventor: Todd E. Smeltzer, Red Lion, PA (US)

(21) Appl. No.: 13/341,538

(22) Filed: Dec. 30, 2011

(51) Int. Cl. F16L 3/08

(52) U.S. Cl. 248/70

(57) ABSTRACT

A cable management system cable tray having a primary and secondary track for receiving a cable chain for connecting components across a rotatable joint of a turret. The cable chain is adapted to shift between the primary and secondary tracks depending on the rotation turret to avoid pulling on the cable chain during the rotation of the turret. The cable management is modular and removable from the turret as single component for repair or replacement.

### FIELD OF THE INVENTION

The present invention is directed to management of cabling and wiring across a rotating joint. More specifically, the present invention is directed to cable management system for a weapon system having a rotatable turret assembly.

### BACKGROUND OF THE INVENTION

A rotatable turret or cab is often mounted on a vehicle chassis to allow for the positioning or orienting of equipment mounted to the turret independently of the orientation of the chassis. For instance, firefighting vehicles often have rotating platforms for positioning ladders and water cannons proximate to the fire while allowing the vehicle to remain a safe distance from the fire. Similarly, military vehicles often comprise weapon systems mounted on turrets so that the turret can be rotated to aim the weapon system at the desired target. While turrets provide numerous advantages in positioning and orienting equipment and weapons system, an inherent challenge with turrets is maintaining electrical and other connections across the rotating joint of the turret.

Vehicles having a turret often comprise systems having at least one component mounted on the turret and another component mounted to the vehicle chassis connected by wiring or cabling extending across the rotating joint of the turret. The rotation of the turret relative to the chassis can pull on the wiring or cabling severing the connectors or pulling the connectors from the components. A typical solution is positioning the connectors to pass through the center of the rotational axis of the rotating joint to minimize the stress placed on the connectors as the turret rotates. However, with many turreted vehicles such as tanks, the vehicle chassis and turret each define interior spaces that are combined to define the crew compartment. In these vehicles, positioning the connectors to extend through the rotational axis of the rotating joint is undesirable as the connectors would be extending through the center of the crew compartment.

Another approach is increasing the length of each connector such that each connector has “slop” to allow the turret to rotate without immediately straining the connector. However, the inherent drawback of this approach is that the slop in each connector must be managed to prevent the connector from becoming entangled as the turret rotates. As the crew compartment is typically very cramped, the large wire or cable management system necessary to control the slop for each of the plurality of connectors competes for the already limited space within the compartment.

### SUMMARY OF THE INVENTION

The present invention is directed to a cable management system having a cable chain that received within a cable tray positioned on the turret along on the periphery of a rotatable joint between the turret and the chassis. The cable chain can receive at least one connector cable for operably connecting a component positioned on the turret to a component positioned on the vehicle chassis. The cable chain comprises a turret mount affixable to the turret proximate to the periphery of the rotatable joint between the turret and vehicle chassis. Similarly, the opposite end of the cable chain comprises a chassis mount affixable to the vehicle chassis proximate to the periphery of the rotatable joint. The cable tray is sized to receive the cable chain in a folded configuration to provide “slop” for the chain to unfold or fold depending on the relative rotation of the turret to the vehicle chassis. The cable tray is shaped to follow the curve of the rotatable joint of the turret and chassis to minimize the amount of space within the crew compartment consumed by the cable management system.

A cable management system, according to an embodiment of the present invention, can generally comprise a cable tray and a cable chain for receiving at least one connector cable. The cable tray further comprises a primary track and a parallel secondary track both shaped to approximate curvature of the rotatable joint. According to an embodiment, the secondary track extends from a predetermined point proximate to the center of the primary track to one end of the primary track. The cable chain further comprises a turret mount at one end of the cable chain affixable to the turret and a chassis mount at the opposite end of the cable chain affixable to the vehicle chassis. The chassis mount is positioned such that the end of the chain affixed to the chassis mount moves within the primary track when the turret is rotated relative to the chassis. Similarly, the turret mount is positioned proximate to the secondary track such that the end of the chain affixed to the turret mount remains fixed at the end of the secondary track proximate the center of the primary track. The cable chain is folded within the cable tray such that a portion of the chain proximate to the chassis mount resides on the primary track and a portion of the chain proximate to the vehicle mount resides on the secondary track.

In operation, when the turret is rotated relative to the chassis such that the chassis and turret mounts are positioned proximate to each other, the chain can be folded nearly in half with approximately half the chain residing on the primary track and the other half of the secondary track. Rotating the turret relative to chassis to move the chassis mount in a first direction toward the end of the secondary track opposite the turret shortens the length of the chain on the primary track and increases the length of the chain on the secondary track until the chain is completely unfolded. While the chassis mount is moving relative to the turret, the position of the chassis mount remains constant to any components mounted to the chassis. Similarly, rotating the turret the opposite direction increases the length of the chain on the primary track while shortening the length of the chain on the secondary track until the chain is nearly completely extended in the opposite direction. According to an embodiment, the primary track is sized such that the chassis mount is proximate the end of the primary track when the chain is nearly fully extended or unfolded.

According to an embodiment, each cable connector can further comprise at least one connector interface at the chassis mount and at least one connector interface at the turret mount. In this configuration, the various components of the vehicle to be connected across the rotatable joint can be connected to the respective connector interface such that the corresponding cable connector serves as the link across the rotatable joint. In this configuration, the cable management system is modular such that the entire system can be removed for repair or replacement as a single line unit once individual components are disconnected from their respective connector interfaces.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description, of various embodiments of the invention in connection with the accompanying drawings, in which:

FIG. 1 is a partial cross-sectional perspective view of a cable management system, according to an embodiment of the present invention, installed on a representative vehicle with a representative turret assembly.

FIG. 2 is a partial cross-sectional perspective view of the cable management system of FIG. 1.

FIG. 3 is an exploded view of a cable management system according to an embodiment of the present invention.

FIG. 4 is a perspective view of a cable management system according to an embodiment of the present invention.

FIG. 5 is a bottom perspective view of the cable management system of FIG. 4.

FIG. 6 is a partial cross-sectional view of the cable management system of FIG. 4.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

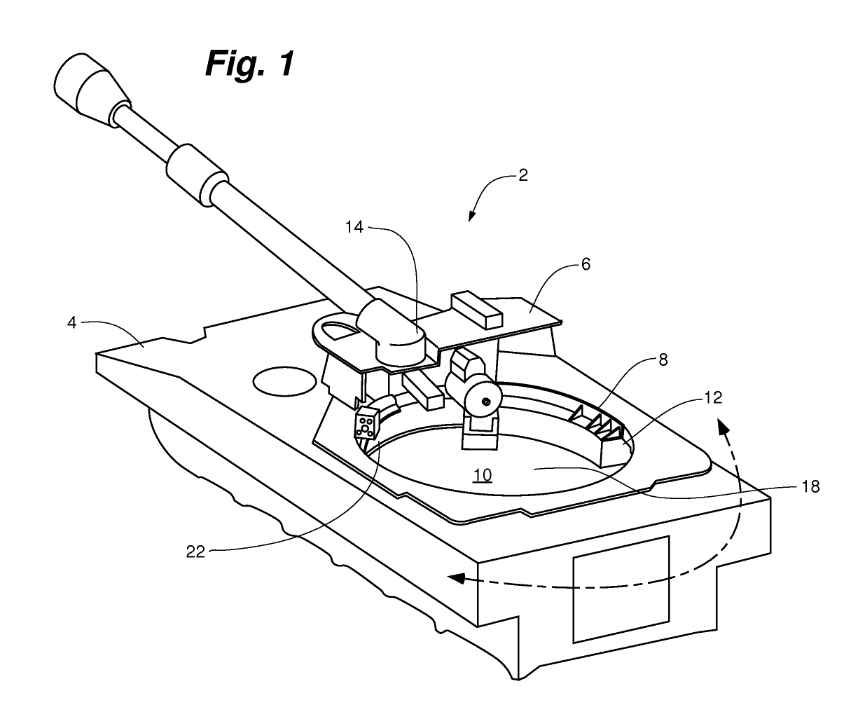

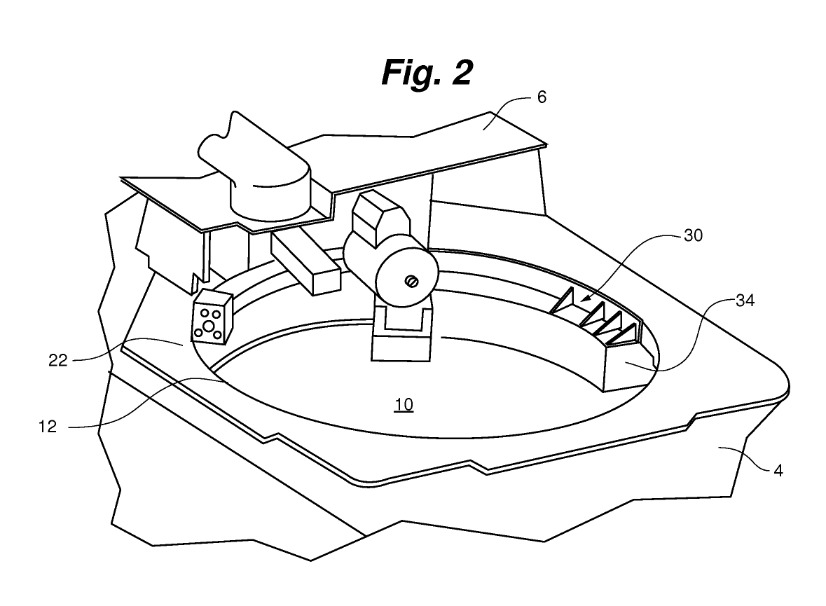

As shown in FIGS. 1-2, a vehicle 2 for use with the present invention generally comprises a vehicle chassis 4, a turret assembly 6 and a rotatable joint 8. The vehicle chassis 4 defines an interior space 10 and a circular opening 12 accessing the interior space 10. The vehicle chassis 4 can further comprise a first component 14 having a first connector 16. Similarly, the turret assembly 6 can further comprise a second component 18 corresponding to the first component 14 and having a second connector 20. The rotatable joint 8 comprises a circular track 22 corresponding to the circular opening 12 of the vehicle chassis 4. In operation, the turret assembly 6 can rotate on the circular track 22 to orient the turret assembly 6 in the desired direction. As depicted, the vehicle 2 is a turreted armored vehicle with a mounted weapon system, but can comprise any vehicle system with a rotatable turret. The vehicle 2 description is not intended to be limiting, but rather to assist in the description of the present invention.

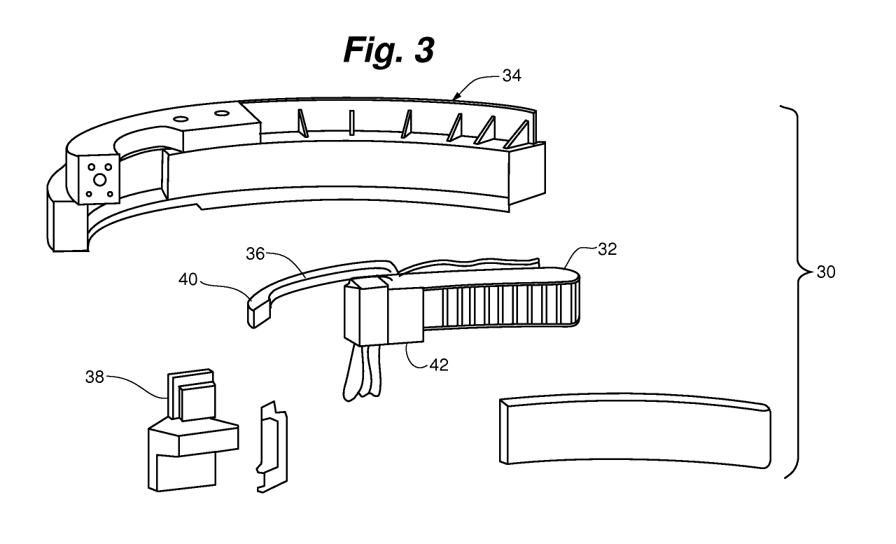

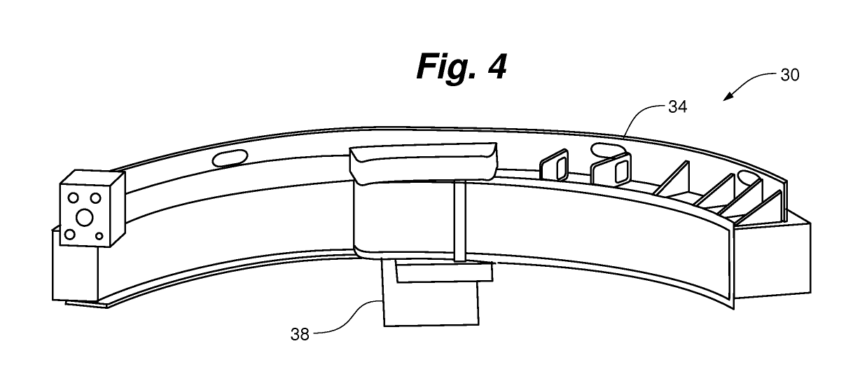

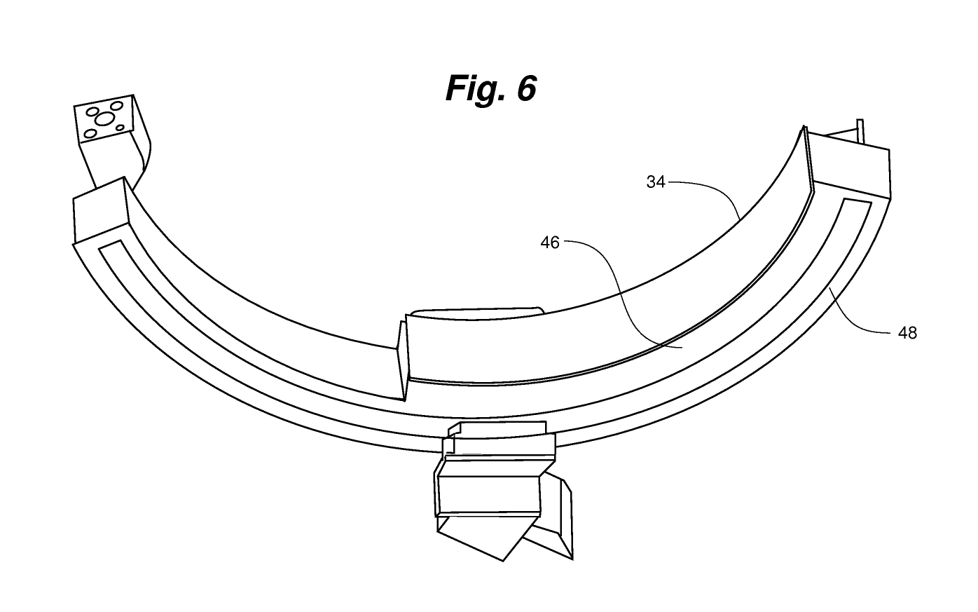

As shown in FIGS. 1-6, a cable management system 30, according to an embodiment of the present invention, comprises a cable chain 32 and a cable tray 34. The cable chain 32 is adapted to receive at least one cable connector 36 extending the length of the cable chain 32. The cable chain 32 can farther comprise a turret mount 38 affixed to one end of the cable chain 32 and having at least one turret connector interface 40 corresponding to each cable connector 36. Similarly, the cable chain 32 can further comprise a chassis mount 42 affixed to the opposite end of the cable chain 32 and having at least one vehicle connector interface 44 corresponding to each cable connector 36. The cable tray 34 further comprises a primary track 46 and a secondary track 48.

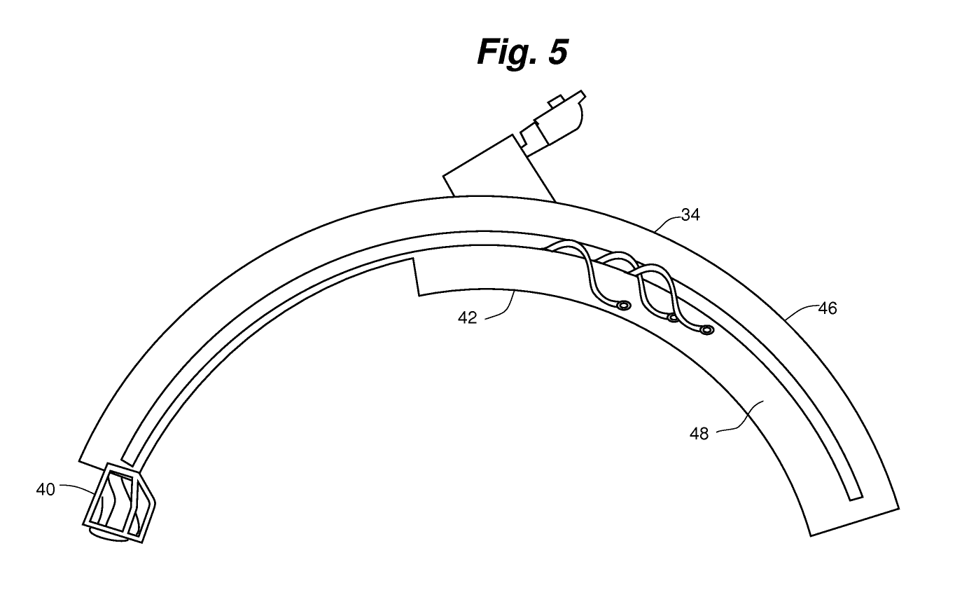

The primary and secondary tracks 46, 48 are shaped to fit the periphery of the circular opening 12. The primary track 46 extends a predetermined distance along periphery of the circular opening 12. Similarly, the secondary track 48 extends from one end of the primary track 46 to a predetermined point proximate to the middle of the primary track 46. The length of the primary and secondary tracks 46, 48 can be varied depending on the size of the circular opening 12 and the extent to which the turret assembly 6 is permitted to rotate around the vehicle chassis 4. As shown in FIG. 5, the primary track 46 comprises an elongated opening 50 for slidably receiving the chassis mount 42.

As shown in FIGS. 1-2, the cable management system 30 is affixed to the turret assembly 6 such that the rotation of the turret assembly 6 relative to the chassis 4 moves the cable tray 34 along the periphery of the circular track 22 of the rotatable joint 8. The chassis mount 42 is mounted to the chassis 4 proximate to the circular opening 12 such that rotation of the turret assembly 6 moves the chassis mount 42 within the elongated track 50 of the primary track 46. The portion of the cable chain 32 proximate the chassis mount 42 is positioned on the primary track 46. Similarly, the turret mount 38 is affixed at the end of the secondary track 48 to position a portion of the cable chain 32 within the secondary track 48. The rotation of the turret assembly 6 in a first direction moves the chassis mount 42 along the primary track 46 toward the common end of the primary and secondary tracks 44, 46. The movement of the chassis mount 42 increases the length of the cable chain 32 on the secondary track 46 until the chassis mount 42 reaches the end of the primary track 44 and the entire cable chain 32 unfolded. Similarly, rotating the turret assembly 6 in opposite direction increases the length of the cable chain 32 on the primary track 44 until the chassis mount 42 reaches the opposite end of the primary track 44. The shifting of the cable chain 32 between the primary and secondary tracks 44, 46 prevents pulling on the cable chain 32 during rotation of the turret assembly 6.

According to an embodiment, the first connector 16 of the first component 14 can be operably linked to vehicle connector interface 44. Similarly, the second connector 20 of the second component 18 can operably linked to the turret connector interface 40 to link the first and second components 14, 18 with cable connector 36 across the rotatable joint 8. The entire cable management system 30 can be removed from the turret assembly 6 by disconnecting the vehicle and turret connector interfaces 40, 44.

While the invention is amenable to various modifications and alternative forms, specifies thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A cable management system for connecting components across a rotatable joint between a rotatable turret assembly mounted on a vehicle chassis, comprising:
a cable tray having a primary track and a parallel secondary track, wherein the cable tray is mountable to the rotatable turret assembly such that rotation of the rotatable turret assembly rotates the primary and secondary tracks; and
a cable chain further comprising:
a chassis mount affixed to a first end of the cable chain and mountable to the vehicle chassis such that rotating the turret assembly relative to the vehicle chassis rotates the primary track past the chassis mount, and
a turret mount affixed to a second end of the cable chain and mountable to the turret assembly such that the turret mount is positioned at a fixed point in the secondary track;
wherein rotating the primary track moves a portion of the cable chain between the primary track and the secondary track to maintain the chassis mount and the turret mount regardless of the relative rotation of the turret assembly.

2. The cable management system of claim 1, wherein the cable tray further comprises a housing for enclosing the cable chain.

3. The cable management system of claim 1, wherein the primary track defines an elongated opening for receiving the chassis mount.

4. The cable management system of claim 1, wherein the primary and secondary tracks are shaped to approximate the shape of the rotatable joint.

5. The cable management system of claim 1, wherein the secondary track is shorter than the primary track.

6. The cable management system of claim 1, wherein the cable management system further comprises at least one cable connector positionable within the cable chain and extending between the chassis and turret mounts.

7. The cable management system of claim 6, wherein the chassis mount further comprises a vehicle connector interface operably linked to a first end of the cable connector, wherein a component mounted to the vehicle can be linked to the cable connector via the vehicle connector interface.

8. The cable management system of claim 6, wherein the turret mount further comprises a turret connector interface operably linked to a second end of the cable connector, wherein a component mounted to the turret can be linked to the cable connector via the turret connector interface.

9. A vehicle, comprising:
a chassis;
a turret,
a rotatable joint positioned between the chassis and the turret such that the turret can rotated relative to the chassis;
a cable management system comprising:
a cable tray having a primary track and a parallel secondary track, wherein the cable tray is mountable to the rotatable turret assembly such that rotation of the rotatable turret assembly rotates the primary and secondary tracks, and
a cable chain further comprising:
a chassis mount affixed to a first end of the cable chain and mountable to the vehicle chassis such that rotating the turret assembly relative to the vehicle chassis rotates the primary track past the chassis mount, and
a turret mount affixed to a second end of the cable chain and mountable to the turret assembly such the turret mount is positioned at a fixed point in the secondary track;
wherein rotating the primary track moves a portion of the cable chain between the primary track and the secondary track to maintain the chassis mount and the turret mount regardless of the relative rotation of the turret assembly.

10. The vehicle of claim 9, wherein the cable tray further comprises a housing for enclosing the cable chain.

11. The vehicle of claim 9, wherein the primary track defines an elongated opening for receiving the chassis mount.

12. The vehicle of claim 9, wherein the primary and secondary tasks are shaped to approximate the shape of the rotatable joint.

13. The vehicle of claim 9, wherein the secondary track is shorter than the primary track.

14. The vehicle of claim 9, wherein the cable management system further comprises at least one cable connector positionable within the cable chain and extending between the chassis and turret mounts.

15. The vehicle of claim 14, wherein the chassis mount further comprises a vehicle connector interface operably linked to a first end of the cable connector, wherein a component mounted to the vehicle can be linked to the cable connector via the vehicle connector interface.

16. The vehicle of claim 14, wherein the turret mount further comprises a turret connector interface operably linked to a second end of the cable connector, wherein a component mounted to the turret can be linked to the cable connector via the turret connector interface.
